(19) United States
(12) Patent Application Publication
(10) Pub. No.: US 2022/0045336 A1
(43) Pub. Date: Feb. 10, 2022

(54) POWDER FOR SOLID OXIDE FUEL CELL AIR ELECTRODE, AND METHOD FOR MANUFACTURING SAID POWDER FOR SOLID OXIDE FUEL CELL AIR ELECTRODE

(71) Applicant: SAKAI CHEMICAL INDUSTRY CO., LTD., Osaka (JP)

(72) Inventors: Norimune Hirata, Osaka (JP); Kazuto Hashimoto, Osaka (JP); Minoru Yoneda, Osaka (JP)

(73) Assignee: SAKAI CHEMICAL INDUSTRY CO., LTD., Osaka (JP)

(21) Appl. No.: 17/435,126

(22) PCT Filed: Jul. 18, 2019
(86) PCT No.: PCT/JP2019/028306

§ 371 Date: Aug. 31, 2021

(30) Foreign Application Priority Data
Mar. 19, 2019 (JP) 2019-051329

(51) Int. Cl. H01M 4/90; H01M 4/88; H01M 8/1213

(52) U.S. Cl. CPC H01M 4/9033; H01M 4/8828; H01M 2008/1293; H01M 4/8885; H01M 8/1213; H01M 4/886

(57) ABSTRACT

A powder for an air electrode in a solid oxide fuel cell, the powder consisting of: a metal composite oxide having a perovskite-type single phase crystal structure represented by A1₁₋ₓA2ₓBO_{3-δ}, where the element A1 is at least one selected from the group consisting of La and Sm, the element A2 is at least one selected from the group consisting of Ca, Sr, and Ba, the element B is at least one selected from the group consisting of Mn, Fe, Co, and Ni, 0<x<1, and the δ is an oxygen deficiency amount. When a cross section of a molded body obtained by compression molding the powder is observed at a magnification of 500 times, and a characteristic X-ray intensity of the element B is measured by an energy dispersive X-ray spectroscopy, the number of regions each having an intensity of 50% or higher of a maximum of the characteristic X-ray intensity of the element B and occupying 0.04% by area or more of the observation field of view is five or less.

### TECHNICAL FIELD

The present invention relates to a powder for an air electrode in a solid oxide fuel cell, and a method for producing the powder.

### BACKGROUND ART

Fuel cells have been increasingly attracting attention in recent years as a clean energy source. In particular, a solid oxide fuel cell (SOFC) using an ion-conductive solid oxide as an electrolyte is excellent in power generation efficiency. The SOFC operates at a temperature as high as about 700° C. to 1000° C. and can use the exhaust heat. Moreover, the SOFC can operate with various fuels, such as hydrocarbon and carbon monoxide gas, and is therefore expected to be widely used from household applications to large-scale power generation applications.

The SOFC usually includes a plurality of cells each having a porous air electrode (cathode), a fuel electrode (anode), and an electrolyte layer interposed therebetween. When air is supplied to the air electrode, a reduction reaction of the oxygen contained in the air occurs, to generate oxygen ions. The oxygen ions pass through the electrolyte layer and reach the fuel electrode, where the oxygen ions react with hydrogen supplied to the fuel electrode, to produce water. At this time, electrons are generated at the fuel electrode, while electrons are consumed at the air electrode.

For commercializing the SOFC, it is desired to improve the cell performance, thereby to reduce the number of cells included in the SOFC and reduce the cost. In order to improve the cell performance, for example, it is required for the air electrode to have a high electrical conductivity and a high open porosity. In Patent Literatures 1 to 4, various studies have been made on a metal composite oxide used as an air electrode material and having a perovskite-type crystal structure represented by ABO₃.

### CITATION LIST

### Patent Literature

[PTL 1] Japanese Laid-Open Patent Publication No. 2009-035447

[PTL 2] Japanese Laid-Open Patent Publication No. 2015-201440

[PTL 3] Japanese Laid-Open Patent Publication No 2016-139523

[PTL 4] Japanese Patent Publication No. 5140787

### SUMMARY OF INVENTION

### Technical Problem

Even with the metal composite oxide disclosed in Patent Literatures 1 to 4, it is difficult to obtain an air electrode having both a high electrical conductivity and a high open porosity.

### Solution to Problem

In view of the above, one aspect of the present invention relates to a powder for an air electrode in a solid oxide fuel cell, the powder consisting of: a metal composite oxide having a perovskite-type single phase crystal structure represented by a following general formula:

A1₁₋ₓA2ₓBO_{3-δ},

where the element A1 is at least one selected from the group consisting of La and Sm, the element A2 is at least one selected from the group consisting of Ca, Sr, and Ba, the element B is at least one selected from the group consisting of Mn, Fe, Co, and Ni, 0<x<1, and the δ is an oxygen deficiency amount, wherein when a cross section of a molded body obtained by compression molding the powder is observed at a magnification of 500 times, and a characteristic X-ray intensity of the element B is measured by an energy dispersive X-ray spectroscopy, the number of regions each having an intensity of 50% or higher of a maximum of the characteristic X-ray intensity of the element B and occupying 0.04% by area or more of the observation field of view is five or less.

Another aspect of the present invention relates to a method of producing a powder for an air electrode in a solid oxide fuel cell, the powder having a perovskite-type single phase crystal structure represented by a following general formula:

A1₁₋ₓA2ₓBO_{3-δ},

where the element A1 is at least one selected from the group consisting of La and Sm, the element A2 is at least one selected from the group consisting of Ca, Sr, and Ba, the element B is at least one selected from the group consisting of Mn, Fe, Co, and Ni, 0<x<1, and the δ is an oxygen deficiency amount,

the method including:

a slurry preparing step of mixing different kinds of metal compounds in a powder form each containing one of the element A1, the element A2, and the element B, with a dispersion medium, to prepare a slurry in which an average particle diameter of the metal compounds is 0.5 μm or more and 2 μm or less,

an adding step of adding a granulating agent to the slurry,

a drying step of removing the dispersion medium in the slurry after the adding step, to obtain a dry powder, and

a baking step of baking the dry powder, wherein

in the slurry subjected to the drying step, a total concentration of the different kinds of metal compounds is 10 mass % or more and below 25 mass %.

### Advantageous Effects of Invention

According to the present invention, it is possible to obtain an air electrode having both a high electrical conductivity and a high open porosity.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1A An example of a binary mapping image of a cross section of a molded body.

FIG. 1B An enlarged view of an area marked in FIG. 1A.

FIG. 2 A flowchart of an example of a manufacturing method according to one embodiment of the present invention.

FIG. 3 An X-ray diffraction chart of a baked powder produced in Example 1.

FIG. 4 A SEM image of a cross section of a molded body produced in Example 1.

FIG. 5 A SEM image of a cross section of a molded body produced in Comparative Example 3.

FIG. 6 A mapping image of a cross section of the molded body produced in Example 1.

FIG. 7 A mapping image of a cross section of the molded body produced in Comparative Example 3.

FIG. 8 A binary mapping image of a cross section of the molded body produced in Example 1.

FIG. 9 A binary mapping image of a cross section of the molded body produced in Comparative Example 3.

### DESCRIPTION OF EMBODIMENTS

The B site in a perovskite-type crystal structure represented by ABO₃ is occupied by a transition metal which can have different valences. Therefore, the electrical conductivity of a metal composite oxide having a perovskite-type crystal structure is prone to be influenced by the metal element that enters the B site.

For the analysis of a crystal structure, an X-ray diffractometry is typically used. Even when a metal composite oxide is evaluated as having only a perovskite-type crystal structure (hereinafter sometimes referred to as a perovskite phase) by an X-ray diffractometry, there may be a case where a close analysis using an electron microscope shows that the metal composite oxide has a region having a crystal structure other than the perovskite-type crystal structure and containing a transition metal (hereinafter sometimes referred to as a non-perovskite phase). For example, in the case of using a raw material containing manganese (Mn) as the transition metal element, the metal composite oxide may have a region composed of a spinel-type crystal derived from manganese oxide, in addition to the perovskite phase. This is because, in the process of mixing and baking different kinds of raw materials (metal compounds) to produce a metal composite oxide, the raw material containing a transition metal partially fails to contribute to the formation of a perovskite phase and forms a non-perovskite region. It has been found that a reduction in electrical conductivity of the metal composite oxide occurs when the non-perovskite region containing a transition metal (element B) that possibly enters the B site is localized over a certain area in the metal composite oxide powder.

In a powder for an air electrode in a solid oxide fuel cell (hereinafter sometimes referred to as an air electrode powder) according to the present embodiment, the non-perovskite region is uniformly distributed to such an extent that the localization cannot be confirmed even by an analysis using an electron microscope.

Specifically, an air electrode powder according to the present embodiment is a powder consisting of a metal composite oxide having a perovskite-type single phase crystal structure represented by a following general formula:

A1₁₋ₓA2ₓBO_{3-δ},

where the element A1 is at least one selected from the group consisting of La and Sm, the element A2 is at least one selected from the group consisting of Ca, Sr, and Ba, the element B is at least one selected from the group consisting of Mn, Fe, Co, and Ni, 0<x<1, and the δ is an oxygen deficiency amount. When a cross section of a molded body obtained by compression molding the powder is observed at a magnification of 500 times, and a characteristic X-ray intensity of the element B is measured by an energy dispersive X-ray spectroscopy, the number of regions each having an intensity of 50% or higher of a maximum of the characteristic X-ray intensity of the element B and occupying 0.04% by area or more of the observation field of view is five or less.

That the air electrode powder has a perovskite-type single phase crystal structure means that no peak is observed other than the peak derived from the perovskite-type crystal phase, in the X-ray diffraction chart. That no peak is observed refers to, typically, that the peaks other than the peak derived from the perovskite-type crystal phase have an intensity equal to or below the detection limit of X-ray diffractometry.

The distribution of the non-perovskite region containing the element B can be confirmed by an element analysis, using an electron microscope, on a cross section of a molded body obtained by compression molding the air electrode powder. Specifically, it can be confirmed as follows.

Two grams of an air electrode powder and 0.4 g of an aqueous polyvinyl alcohol solution (concentration: 10 mass %) are put into a mortar and mixed. Subsequently, the mixture is allowed to stand at 110° C. for one hour in a box-type dryer, to remove water, and then passed through a sieve with an aperture of 150 μm, to give a granulated powder. Next, 0.5 g of the granulated powder is packed into a 10 mm by 5 mm rectangular mold die, and pressure molded at a molding pressure of 100 MPa for 60 seconds, into a molded body. The molded body desirably has a density of 3.5 g/cm³ or more and 4.5 g/cm³ or less. When the molded body is formed to have a density within this range, a sufficient number of particles of the air electrode powder can be included in an observation field of view of a scanning electron microscope, and the shape of the powder can be maintained without being compressed excessively.

The resultant molded body is subjected to an Ar ion etching at a voltage of 5.0 kV for 20 hours, using a cross section polisher (e.g., SM-09010, available from JEOL Ltd.), to expose a cross section of the sample. The exposed cross section is observed at a magnification of 500 times, using a scanning electron microscope (SEM), to determine an observation field of view (a 180 μm by 240 μm region). In the observation field of view, a mapping image is acquired using an energy dispersive X-ray detector (e.g., INCA X-sight, available from Oxford Instruments) under the conditions shown below. In the mapping image, the contrast between light and dark is emphasized on the basis of the intensity of the characteristic X-ray Kα of the element B.

Acceleration voltage: 15 kV

Process time: 4

Dead time: 30 to 40%

Resolution: 128 by 96 pixels

Number of times of scanning: 10 times

The acquired mapping image is segmented into two: a pixel Pa having an intensity of 50% or higher of the maximum intensity, and a pixel Pb having an intensity lower than 50% of the maximum intensity, thereby to acquire a binary mapping image. In the binary mapping image, a region R where five or more pixels Pa are continuously present with sharing adjacent sides is determined. The 0.04% by area of the observation field of view is equivalent to five pixels in the 128 by 96 pixel mapping image. When the number of the regions R observed in the observation field exceeds five, it is defined that the element B is localized.

When the element B that does not contribute to the formation of the perovskite phase is finely dispersed without being localized, the conductivity can be improved. This can improve the power generation performance per unit cell. Furthermore, the stability of the perovskite phase at high temperatures can be enhanced. This can improve the durability of the fuel cell.

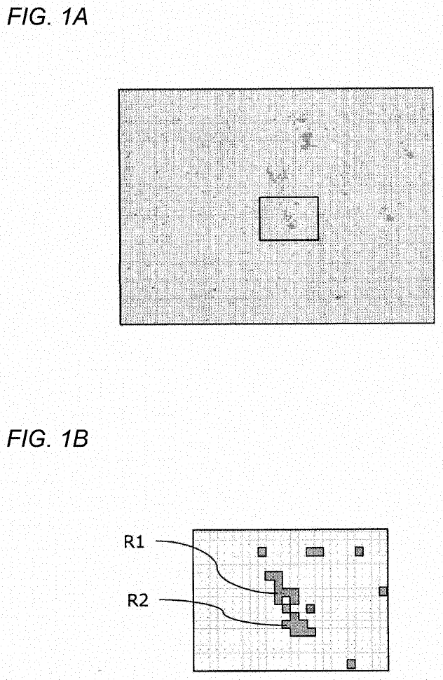

FIG. 1A is an example of the binary mapping image obtained in the manner as above. FIG. 1B is an enlarged view of an area marked in FIG. 1A. FIG. 1B includes two regions R each having an intensity of 50% or higher of the maximum intensity and occupying 0.04% by area or more of the observation field of view, i.e., a region R1 where eight pixels are continuously present, and a region R2 where seven pixels are continuously present.

The element A1 is at least one selected from the group consisting of La (lanthanum) and Sm (samarium). The element A2 is at least one selected from the group consisting of Ca (calcium), Sr (strontium), and Ba (barium). The element B is at least one selected from the group consisting of Mn (manganese), Fe (iron), Co (cobalt), and Ni (nickel). The x satisfies 0<x<1, and the δ is an oxygen deficiency amount.

The element A1 preferably includes La. The content of La in the element A1 may be 90 atom % or more. The element A2 preferably includes Sr. The element A2 may include Sr and Ca. The content of Sr in the element A2 may be 90 atom % or more. When the element A2 includes Sr and Ca, the total content of them may be 90 atom % or more. The atomic ratio: Ca/Sr of Ca to Sr may be 0.2 or more and 4.0 or less, and may be 0.6 or more and 1.5 or less. The x is not specifically limited, and for example, may be 0.2≤x≤0.6, and may be 0.3≤x≤0.5. The element B preferably includes Mn. The content of Mn in the element B may be 90 atom % or more.

Specifically, the metal composite oxide is exemplified by lanthanum strontium cobalt ferrite (LSCF, La₁₋ₓ₁Srₓ₁Co_{1-y1}Fe_{y1}O_{3-δ}, where 0<x1<1 and 0<y1<1), lanthanum strontium manganite (LSM, La₁₋ₓ₂Srₓ₂MnO_{3-δ}, where 0<x2<1), lanthanum strontium cobaltite (LSC, La₁₋ₓ₃Srₓ₃CoO_{3-δ}, 0<x3<1), samarium strontium cobaltite (SSC, Sm₁₋ₓ₄Srₓ₄CoO_{3-δ}, where 0<x4<1), and lanthanum strontium calcium manganite (LSCM, La_{1-x5-y2}Srₓ₅Ca_{y2}MnO_{3-δ}, where 0<x5<1 and 0<y2<1). In view of the conductivity and the coefficient of thermal expansion, preferred are LSM and LSCM in which the element A1 is La, the element A2 is Sr (and Ca), and the element B is Mn.

The specific surface area of the air electrode powder is not specifically limited, but the air electrode powder preferably has a specific surface area based on a BET method (BET specific surface area) of 0.05 m²/g or more and 0.3 m²/g or less. When the specific surface area of the air electrode powder is below 0.05 m²/g, sintering hardly proceeds in the process of heat treatment for forming into an air electrode, which may result in an insufficient strength of the electrode. The BET specific surface area of the air electrode powder is more preferably 0.07 m²/g or more, further more preferably 0.09 m²/g or more. On the other hand, when the specific surface area of the air electrode powder exceeds 0.3 m²/g, sintering may proceed excessively in the process of heat treatment for forming into an air electrode. In this case, the obtained air electrode tends to have a low open porosity, and the diffusivity of air may be insufficient. The BET specific surface area of the air electrode powder is more preferably 0.25 m²/g or less, further more preferably 0.20 m²/g or less. The BET specific surface area is measured by the BET method in accordance with JIS Z 8830: 2013.

The average particle diameter of the air electrode powder (hereinafter, the baked material D50) is not specifically limited, but is preferably 10 μm or more and 35 μm or less. When the baked material D50 is below 10 μm, sintering may proceed excessively in the process of heat treatment for forming into an air electrode. In this case, the obtained air electrode tends to have a low open porosity, and the diffusivity of air may be insufficient. The baked material D50 is more preferably 13 μm or more, further more preferably 16 μm or more. On the other hand, when the baked material D50 exceeds 35 μm, sintering may hardly proceed, which may result in an insufficient strength of the electrode. The baked material D50 is more preferably 31 μm or less, further more preferably 27 μm or less.

The average particle diameter is a particle diameter at 50% cumulative volume in a volumetric particle size distribution as measured by a laser diffractometry (this applies hereinafter). In other words, in a volume-based cumulative particle amount curve obtained through the particle size distribution measurement by a laser diffractometry, a particle diameter at which the cumulative amount occupies 50% is determined as the average particle diameter.

D10 and D90 particle diameters of the air electrode powder are not particularly limited. The D10 refers to a particle diameter at which the cumulative amount occupies 10% in the cumulative particle amount curve obtained in the manner as above. The D90 refers to a particle diameter at which the cumulative amount occupies 90% in the cumulative particle amount curve obtained in the manner as above. The closer to one the value obtained by dividing D90 by D10 (D90/D10) is, the sharper the particle size distribution curve is.

The D90/D10 is not particularly limited, but is preferably 5 or less. When the D90/D10 exceeds 5, in the process of heat treatment for forming into an air electrode, sintering may fail to proceed uniformly, causing a crack. In this case, the yield tends to be lowered. The D90/D10 is more preferably 4 or less, further more preferably 3.5 or less.

### (Production Method of Air Electrode Powder)

The air electrode powder can be produced by a method including, for example, steps of uniformly mixing different kinds of metal compounds in a powder form each containing one of the element A1, the element A2, and the element B, with a dispersion medium, to prepare a slurry (slurry preparing step); adding a granulating agent (adding step); removing the dispersion medium, to obtain a dry powder in which the different kinds of metal compounds are dispersed uniformly and have a uniform particle size (drying step); and reacting the different kinds of metal compounds with each other by baking, to obtain a baked powder having a perovskite-type crystal structure (baking step). Here, the total concentration of the different kinds of metal compounds in the slurry to be subjected to the drying step (concentration in a later-described second slurry) is 10 mass % or more and below 25 mass %.

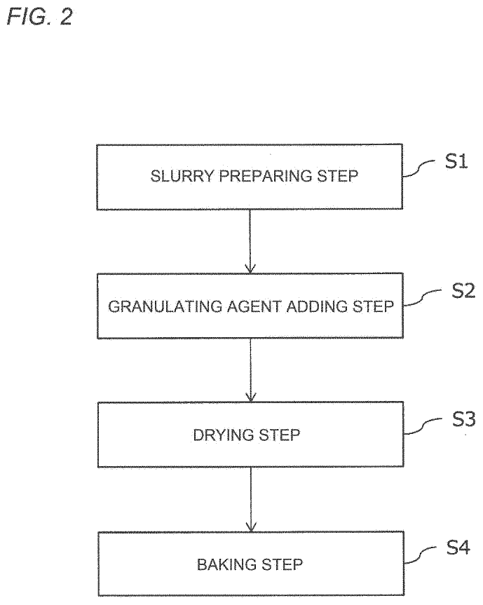

FIG. 2 is a flowchart of an example of a manufacturing method according to the present embodiment.

The production method according to the present embodiment will be described below by each step.

### (1) Slurry Preparing Step

A slurry can be prepared by mixing different kinds of metal compounds in a powder form each containing one of the element A1, the element A2, and the element B, with a dispersion medium.

A metal compound containing the element A1 (first compound) includes, for example, lanthanum carbonate (La₂(CO₃)₃), lanthanum hydroxide (La(OH)₃), lanthanum oxide (La₂O₃), samarium carbonate (Sm₂(CO₃)₃), samarium hydroxide (Sm(OH)₃), and samarium oxide (Sm₂O₃).

A metal compound containing the element A2 (second compound) includes, for example, strontium carbonate (SrCO₃), strontium hydroxide (Sr(OH)₂), calcium carbonate (CaCO₃), calcium hydroxide (Ca(OH)₂), barium carbonate (BaCO₃), and barium hydroxide (Ba(OH)₂).

A metal compound containing the element B (third compound) includes, for example, manganese oxide (e.g., MnO₂, Mn₃O₄), manganese carbonate (MnCO₃), iron oxide (Fe₂O₃), cobalt oxide (CO₃O₄), cobalt carbonate (CoCO₃), nickel oxide (NiO), and nickel carbonate (NiCO₃).

The dispersion medium is not specifically limited. In view of the ease of handling and the reduction of impurity amount, the dispersion medium may contain water (ion-exchanged water) as a major component (component occupying 50% or more of the whole mass), and is preferably composed only of water (ion-exchanged water).

The metal compounds dispersed in a slurry prepared in the present step (hereinafter, a first slurry) have an average particle diameter (hereinafter, a dispersed material D50) of 0.5 μm or more and 2.0 μm or less.

When the dispersed material D50 is below 0.5 μm, the different kinds of metal compounds tends to aggregate unevenly. Consequently, the composition of the resultant air electrode powder becomes non-uniform, and a localization of the element B occurs. The dispersed material D50 is more preferably 0.7 μm or more, further more preferably 0.9 μm or more. When the dispersed material D50 exceeds 2.0 μm, the reaction between the different kinds of metal compounds is unlikely to proceed uniformly even through the baking step, and a localization of the element B occurs in the resultant air electrode powder. The dispersed material D50 is more preferably 1.7 μm or less, further more preferably 1.5 μm or less.

The dispersed material D50 is calculated from a particle size distribution measured on all the particles in the first slurry (i.e., regardless of whether they are of the metal compounds, or of the reaction products and composites thereof).

The first slurry may have any viscosity. The viscosity of the first slurry as measured using a B-type viscometer under the conditions of a temperature of 23° C. to 27° C. and a rotation rate of 60 rpm may be 1 mPa·s or more, and may be 3 mPa·s or more. The viscosity of the first slurry as measured in the same manner as above may be 500 mPa·s or less, and may be 100 mPa·s or less. The above viscosity is measured in accordance with JIS Z 8803.

The metal compounds may be pulverized in the slurry preparing step so that the dispersed material D50 falls within the range above. The mixing and pulverizing are performed using, for example, a media agitation-type fine pulverizer, such as a planetary mill.

In the present step, a dispersant may be further mixed. In this case, the dispersed material D50 can be easily within the desired range.

The dispersant is not specifically limited, and may be any conventionally known dispersant.

When the dispersion medium contains water as a major component, the dispersant that can be used in this case include: an anionic dispersant, such as polycarboxylic acid salt, polyacrylic acid salt, naphthalenesulfonic acid formalin condensate salt, alkylsulfonic acid salt, and polyphosphoric acid salt; a nonionic dispersant, such as polyalkylene oxide and polyoxyalkylene fatty acid ester; and a cationic dispersant, such as quaternary ammonium salt.

In particular, an anionic dispersant is desirable. For example, a polyacrylic acid salt can be used. Examples of the cation forming a salt include a sodium ion, a potassium ion, a magnesium ion, an ammonium ion, and a calcium ion.

The dispersant may be added in any amount. In view of the diffusion effect, the dispersant is preferably added in an amount of 0.001 parts by mass or more and 0.075 parts by mass or less, more preferably 0.0015 parts by mass or more and 0.01 parts by mass or less, per 100 parts by mass of the total of the metal compounds.

### (2) Adding Step

A granulating agent is added to the first slurry, to prepare a second slurry.

With the granulating agent, the metal compound powders can easily come in close contact with each other. In the slurry preparing step, the metal compounds are pulverized until the dispersed material D50 falls within the range above. This means that the metal compounds which have been sufficiently pulverized can easily aggregate with each other, and thus, the average particle diameter of a dry powder to be obtained (hereinafter, a dry material D50) can be controlled within a desired range, and the composition ratio of the metal compounds contained in a dry powder to be obtained becomes uniform. Furthermore, with the granulating agent, the dry powder can easily take a spherical shape. Thus, the localization of the element B can be suppressed in the air electrode powder obtained in the subsequent baking step.

The granulating agent is added before the dispersion medium is removed from the second slurry in the drying step. The granulating agent may be added in the slurry preparing step. The above dispersed material D50 refers to an average particle diameter of the metal compounds contained in the first slurry before the granulating agent is added.

The granulating agent is not specifically limited, and may be any conventionally known granulating agent.

Examples of the granulating agent include polyvinyl alcohol, gelatin, methyl cellulose, carboxymethyl cellulose, polyvinylpyrrolidone, and polyethylene glycol.

The granulating agent may be added in any amount. In view of the granulating effect, the granulating agent is preferably added in an amount of 0.2 parts by mass or more and 4 parts by mass or less, more preferably 0.5 parts by mass or more and 3 parts by mass or less, per 100 parts by mass of the total of the metal compounds.

### (3) Drying Step

The second slurry is dried, to remove the dispersion medium.

The total concentration of the different kinds of metal compounds contained in a slurry subjected to the drying step (i.e., a second slurry) is 10 mass % or more and below 25 mass %, relative to the total of the dispersion medium and the metal compounds.

When the total concentration of the metal compounds is below 10 mass %, due to a high content of the solvent relative to the metal compounds, the particle size distribution of the dry material becomes broad. In this case, when the resultant dry powder is baked and subsequently subjected to a heat treatment for forming into an air electrode, sintering is unlikely to proceed uniformly, causing a crack. The total concentration of the metal compounds is more preferably 15 mass % or more, further more preferably 20 mass % or more. When the total concentration of the metal compounds is 25 mass % or more, the composition of the resultant air electrode powder becomes non-uniform, and a localization of the element B occurs. The total concentration of the metal compounds is more preferably 24 mass % or less, further more preferably 23 mass % or less.

The second slurry may be dried by any method, such as spray drying, hot-air drying, vacuum drying, and evaporation drying. In particular, a spray drying is preferred because the resultant dry powder tends to be spherical. Furthermore, according to a spray drying, the metal compound powders contained in the dry powder are more likely to come closer to each other. Typically, in the case of synthesizing a composite oxide by a solid phase method from a mixture of different kinds of metal compound powders, the atoms contained in the metal compounds are diffused by thermal energy, to form a composite oxide having a novel composition and crystal structure. In this process, when the metal compound powders are present closely to each other, the atoms can be easily diffused, tending to form a composite oxide having a uniform composition.

In the second slurry subjected to a spray drying, a viscosity as measured using a B-type viscometer under the conditions of a temperature of 23° C. to 27° C. and a rotation rate of 60 rpm may be, for example, 1 mPa·s or more, and may be 3 mPa·s or more. The viscosity of the second slurry may be 100 mPa·s or less, and may be 50 mPa·s or less.

The dry material D50 is not specifically limited, but is preferably 10 μm or more and 50 μm or less. When the dry material D50 is below 10 μm, sintering of the dry powder tends to proceed excessively in the baking step. In this case, an average particle diameter or particle size distribution that is suitable as an air electrode powder is hardly obtained. The dry material D50 is more preferably 15 μm or more, more preferably 25 μm or more. When the dry material D50 exceeds 50 μm, the composition of the metal compounds in the dry powder may be non-uniform. The composition of an air electrode powder to be obtained also tends to be non-uniform, and a localization of the element B becomes likely to occur. The dry material D50 is more preferably 48 μm or less, more preferably 45 μm or less.

The ratio of the dispersed material D50 to the dry material D50 is not specifically limited. The ratio: Dispersed material D50/Dry material D50 of the dispersed material D50 to the dry material D50 is preferably 0.015 or more and 0.05 or less because a desired dry material D50 can be easily obtained. When Dispersed material D50/Dry material D50 is in this range, in a subsequent baking step, the solid phase reaction between the metal compounds and the sintering of the dry powders tend to proceed appropriately. Therefore, a localization of the element B is unlikely to occur, and the open porosity of the air electrode obtained using this powder is unlikely to be excessively small. Dispersed material D50/Dry material D50 is more preferably 0.019 or more and 0.043 or less, more preferably 0.023 or more and 0.035 or less.

The ratio of the baked material D50 to the dry material D50 is not specifically limited. The ratio: Baked material D50/Dry material D50 of the baked material D50 to the dry material D50 is preferably 1 or less. When Baked material D50/Dry material D50 is 1 or less, this indicates that sintering between the metal compounds contained in the dry powder has proceeded further than that of the dry powders to each other, in the subsequent baking step. Therefore, the composition of a baked powder to be obtained can be expected to be more uniform.

### (4) Baking Step

The dry powder is baked. This can provide a metal composite oxide (air electrode powder) containing the metal elements that have been contained in the metal compounds.

The baking temperature is not specifically limited. In view of facilitating the diffusion of each metal element, the baking temperature may be 1200° C. or higher, and may be 1350° C. or higher. In view of suppressing a rapid and excessive sintering, the baking temperature may be 1500° C. or lower, may be 1450° C. or lower, and may be 1400° C. or lower. The baking temperature is, for example, 1350° C. or higher and 1450° C. or lower. When the baking temperature is in this range, sintering between the metal compounds contained in the dry powder is more likely to proceed than sintering between the dry powders.

### EXAMPLES

The present invention will be specifically described below with reference to Examples. The Examples, however, are not intended to limit the scope of the invention.

A description will be given first of a measurement or calculation method of each physical property related to the air electrode powder and others.

### (a) Specific Surface Area

Measurement was made using a specific surface area analyzer (Flowsorb II, available from Micromeritics Instrument Corporation) by the BET method. The heat treatment was performed at 230° C. for 30 minutes under a pure nitrogen gas flow, using as a carrier gas, a mixed gas of 30% nitrogen and 70% helium.

### (b) Particle Size Distribution and Particle Diameters D50, D90 and D10

A sample was added to an aqueous solution of 0.025 wt % sodium hexametaphosphate, to adjust the concentration such that the laser transmittance became 80 to 90%. The particle size distribution was measured using a laser diffraction-scattering type particle size distribution analyzer (MT-3300 EX II, available from MicrotracBEL Corp.).

In the measurement of a particle size distribution to determine the dispersed material D50 and the baked material D50, after the sample was added to the above aqueous sodium hexametaphosphate solution to adjust the concentration as above, a dispersion treatment was performed before the measurement, at an output power of 300 pA for three minutes using an ultrasonic homogenizer (US-600T, available from Nihonseiki Kaisha Ltd.).

The measurement conditions were as follows.
Measurement mode: MT-3300
Particle refractive index: 2.40
Refractive index of liquid medium: 1.333
Particle shape: non-spherical
Dispersion medium: aqueous solution of 0.025 wt % sodium hexametaphosphate

### (c) X-Ray Diffraction

Using an X-ray diffractometer (RINT TTRIII, available from Rigaku Corporation, X-ray radiation source: CuKα, tube voltage: 50 kV, current: 300 mA, long slit: PSA200 (overall length: 200 mm, designed opening angle: 0.0570)), a diffraction pattern was acquired under the following conditions.

Optical system: parallel optical system

Measuring method: continuous measurement

Scanning speed: 5° per minute

Sampling width: 0.04°

Scan range (2θ): 20 to 600

### Example 1

### (1) Slurry Preparing Step

First, 49.97 g of lanthanum oxide (La₂O₃, available from FUJIFILM Wako Pure Chemical Industries, Ltd., purity: 98%), 31.14 g of strontium carbonate (SrCO₃, available from FUJIFILM Wako Pure Chemical Industries, Ltd., purity: 95%), and 68.89 g of manganese carbonate (MnCO₃, available from FUJIFILM Wako Pure Chemical Industries, Ltd., purity: 88%) were put into a resin pot with a capacity of 500 mL.

Into the resin pot, 300 mL of ion-exchanged water, 0.75 g of ammonium polyacrylate (Wako first grade, available from FUJIFILM Wako Pure Chemical Industries, Ltd.) serving as a dispersant, and 150 mL of zirconia beads having a diameter of 1 mm were added, and they were mixed and pulverized at 180 rpm for 75 minutes using a planetary ball mill (P-5, available from Fritsch Co., Ltd.). Then, the beads were removed, to give a first slurry.

In the first slurry, the dispersed material D50 was 1.0 μm. The viscosity of the first slurry as measured using a B-type viscometer under the conditions of a temperature of 23° C. to 27° C. and a rotation rate of 60 rpm was 44 mPa·s.

### (2) Adding Step

After adjusting the concentration of the metal compounds to 23 mass % by adding ion-exchanged water to the first slurry, 1.50 g of polyvinyl alcohol (special grade chemical, available from FUJIFILM Wako Pure Chemical Industries, Ltd.) was added as a granulating agent, and dissolved. The viscosity of the prepared second slurry as measured under above conditions was 7 mPa·s.

### (3) Drying Step

The second slurry was dried using a spray dryer (Spray bag dryer BDP-10, available from Ohkawara Kakohki Co., Ltd.) under the conditions of an inlet temperature of 210° C., an outlet temperature of 100° C., and an atomizer rotation rate of 15,000 rpm, to give a dry powder.

The dry material D50 was 31 μm.

### (4) Baking Step

The above dry powder was packed in a crucible made of alumina, and the crucible was placed in an electric furnace (SB-2025, available from Motoyama Corporation) and baked at 1400° C. for two hours with a temperature increase/decrease rate of 100° C./h. Thereafter, the mixture was crushed with a mortar made of alumina, and passed through a sieve with an aperture of 500 μm, to give a baked powder.

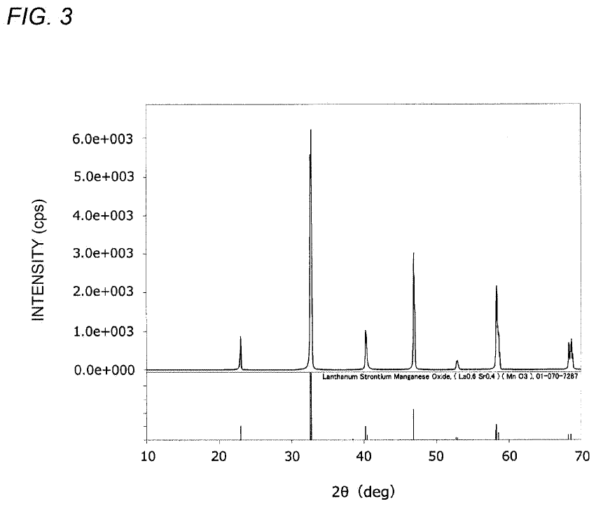

The analysis of an X-ray diffraction pattern confirmed that the above baked powder had only a perovskite-type crystal structure represented by a composition formula: La_{0.6}Sr_{0.4}MnO₃. FIG. 3 is an X-ray diffraction chart of the baked powder produced in Example 1. The peak pattern of the resultant baked powder agreed with the peak pattern of the perovskite phase, and no peak pattern derived from other crystal phases was observed.

The specific surface area of the above baked powder was 0.18 m²/g, and the baked material D50 was 17 μm, and the D90/D10 was 3.4.

### Example 2

### (1) Slurry Preparing Step

First, 43.60 g of lanthanum oxide (La₂O₃, available from FUJIFILM Wako Pure Chemical Industries, Ltd., purity: 98%), 20.38 g of strontium carbonate (SrCO₃, available from FUJIFILM Wako Pure Chemical Industries, Ltd., purity: 95%), 13.89 g of calcium carbonate (CaCO₃, available from FUJIFILM Wao Pure Chemical Industries, Ltd., purity 99.5%), and 72.13 g of manganese carbonate (MnCO₃, available from FUJIFILM Wako Pure Chemical Industries, Ltd., purity 88%) were put into a resin pot with a capacity of 500 mL.

Into the resin pot, 300 mL of ion-exchanged water, 0.75 g of ammonium polyacrylate (Wako first grade, available from FUJIFILM Wako Pure Chemical Industries, Ltd.) serving as a dispersant, and 150 mL of zirconia beads having a diameter of 1 mm were added, and they were mixed and pulverized at 180 rpm for 60 minutes using a planetary ball mill (P-5, available from Fritsch Co., Ltd.). Then, the beads were removed, to give a first slurry.

In the first slurry, the dispersed material D50 was 1.0 μm. The viscosity of the first slurry as measured under the above conditions was 41 mPa·s.

### (2) Adding Step

After adjusting the concentration of the metal compounds to 23 mass % by adding ion-exchanged water to the first slurry, 1.50 g of polyvinyl alcohol (special grade chemical, available from FUJIFILM Wako Pure Chemical Industries, Ltd.) was added as a granulating agent, and dissolved. The viscosity of the prepared second slurry as measured under above conditions was 5 mPa·s.

### (3) Drying Step

The second slurry was dried using a spray dryer (Spray bag dryer BDP-10, available from Ohkawara Kakohki Co., Ltd.) under the conditions of an inlet temperature of 210° C., an outlet temperature of 100° C., and an atomizer rotation rate of 15,000 rpm, to give a dry powder.

The dry material D50 was 41 μm.

### (4) Baking Step

The above dry powder was packed in a crucible made of alumina, and the crucible was placed in an electric furnace (SB-2025, available from Motoyama Corporation) and baked at 1400° C. for two hours with a temperature increase/decrease rate of 100° C./h. Thereafter, the mixture was crushed with a mortar made of alumina, and passed through a sieve with an aperture of 500 μm, to give a baked powder.

The analysis of an X-ray diffraction pattern confirmed that the above baked powder had only a perovskite-type crystal structure represented by a composition formula: La_{0.5}Sr_{0.25}Ca_{0.25}MnO₃.

The specific surface area of the above baked powder was 0.10 m²/g, and the baked material D50 was 26 μm, and the D90/D10 of the baked material was 2.7.

### Comparative Example 1

### (1) Slurry Preparing Step

A first slurry was prepared in the same manner as in Example 2, except that the ion-exchanged water was added in an amount of 64 mL, and the processing time in a planetary ball mill was set to 185 minutes.

In the first slurry, the dispersed material D50 was 1 μm. The viscosity of the first slurry as measured under the above conditions was 23 mPa·s.

### (2) Drying Step

Ion-exchanged water was added to the first slurry, to adjust the concentration of the metal compounds to 63 mass %. No granulating agent (polyvinyl alcohol) was added to the first slurry. The viscosity of the prepared slurry as measured under the above conditions was 13 mPa·s.

The slurry was dried in the same manner as in Example 2, except that the outlet temperature of the spray dryer was set to 75° C., and the atomizer rotation rate was set to 20,000 rpm, to give a dry powder.

The dry material D50 was 36 μm.

### (3) Baking Step

The above dry powder was baked, crushed and sieved in the same manner as in Example 2, to give a baked powder.

The analysis of an X-ray diffraction pattern confirmed that the above baked powder had only a perovskite-type crystal structure represented by a composition formula: La_{0.5}Sr_{0.25}Ca_{0.25}MnO₃.

The specific surface area of the above powder was 0.15 m²/g, and the baked material D50 was 20 μm, and the D90/D10 of the baked material was 5.6.

### Comparative Example 2

### (1) Slurry Preparing Step

A first slurry was prepared in the same manner as in Example 2, except that the ion-exchanged water was added in an amount of 150 mL, and the zirconia beads used had a diameter of 3 mm.

In the first slurry, the dispersed material D50 was 2.2 μm. The viscosity of the first slurry as measured under the above conditions was 31 mPa·s.

### (2) Adding Step

After adjusting the solid content concentration to 23 mass % by adding ion-exchanged water to the first slurry, 1.50 g of polyvinyl alcohol (special grade chemical, available from FUJIFILM Wako Pure Chemical Industries, Ltd.) was added as a granulating agent, and dissolved. The viscosity of the prepared second slurry as measured under above conditions was 5 mPa·s.

### (3) Drying Step

A dry powder was obtained in the same manner as in Example 2, except that the outlet temperature of the spray dryer was set to 75° C.

The dry material D50 was 41 μm.

### (4) Baking Step

The above dry powder was baked, crushed and sieved in the same manner as in Example 2, to give a baked powder.

The analysis of an X-ray diffraction pattern confirmed that the above baked powder had only a perovskite-type crystal structure represented by a composition formula: La_{0.5}Sr_{0.25}Ca_{0.25}MnO₃.

The specific surface area of the above powder was 0.19 m²/g, and the baked material D50 was 27 μm, and the D90/D10 of the baked powder was 3.0.

### Comparative Example 3

First, 54.28 g of lanthanum carbonate (La₂(CO₃)₃, available from FUJIFILM Wako Pure Chemical Industries, Ltd., purity: 99.5%), 18.33 g of strontium carbonate (SrCO₃, available from FUJIFILM Wako Pure Chemical Industries, Ltd., purity: 95%), 12.49 g of calcium carbonate (CaCO₃, FUJIFILM Wako Pure Chemical Industries, Ltd., purity: 99.5%), and 64.89 g of manganese carbonate (MnCO₃, available from FUJIFILM Wako Pure Chemical Industries, Ltd., purity: 88%) were put into a reaction vessel of a sample mill (SK-M10, available from Kyoritsu Riko Co., Ltd.), and mixed and pulverized at a motor rotation rate of 14,000 rpm for 60 seconds, thereby to give a raw material mixed powder.

The average particle diameter of the above raw material mixed powder (dry material D50) was 13 μm.

The above raw material mixed powder was baked, crushed and sieved in the same manner as in Example 2, except that the baking temperature was set to 1450° C., to give a baked powder.

The analysis of an X-ray diffraction pattern confirmed that the above baked powder had only a perovskite-type crystal structure represented by a composition formula: La_{0.5}Sr_{0.25}Ca_{0.25}MnO₃.

The specific surface area of the above powder was 0.20 m²/g, and the baked material D50 was 32 μm, and the D90/D10 of the baked powder was 6.1.

### Comparative Example 4

### (1) Slurry Preparing Step

A first slurry was prepared in the same manner as in Example 2.

In the first slurry, the dispersed material D50 was 1.0 μm. The viscosity of the first slurry as measured under the above conditions was 41 mPa·s.

### (2) Drying Step

Ion-exchanged water was added to the first slurry, to adjust the concentration of the metal compounds to 23 mass %. No granulating agent (polyvinyl alcohol) was added to the slurry. The viscosity of the prepared slurry as measured under the above conditions was 4 mPa·s.

The prepared slurry was dried in the same manner as in Example 2, to give a dry powder.

The dry material D50 was 4.1 μm.

### (3) Baking Step

The above dry powder was baked, crushed and sieved in the same manner as in Example 2, to give a baked powder.

The analysis of an X-ray diffraction pattern confirmed that the above baked powder had only a perovskite-type crystal structure represented by a composition formula: La_{0.5}Sr_{0.25}Ca_{0.25}MnO₃.

The specific surface area of the above powder was 0.34 m²/g, and the baked material D50 was 13 μm, and the D90/D10 of the baked powder was 10.4.

The baked powders obtained in Examples 1 and 2 and Comparative Examples 1 to 4 were evaluated as follows. The results are shown in Table 1.

### (A) Segregation State of Mn

Two grams of the baked powder and 0.4 g of an aqueous polyvinyl alcohol solution (concentration: 10 mass %) were put into a mortar and mixed. Subsequently, the mixture was allowed to stand at 110° C. for one hour in a box-type dryer, to remove water, and then passed through a sieve with an aperture of 150 μm, to give a granulated powder. Next, 0.5 g of the granulated powder was packed into a 10 mm by 5 mm rectangular mold die, and compression molded at a molding pressure of 100 MPa for 60 seconds, into a molded body. The density of the molded body was 3.6 to 4.1 g/cm³.

The molded body was subjected to an Ar ion etching at a voltage of 5.0 kV for 20 hours, using a cross section polisher (SM-09010, available from JEOL Ltd.), to expose a cross section of the sample.

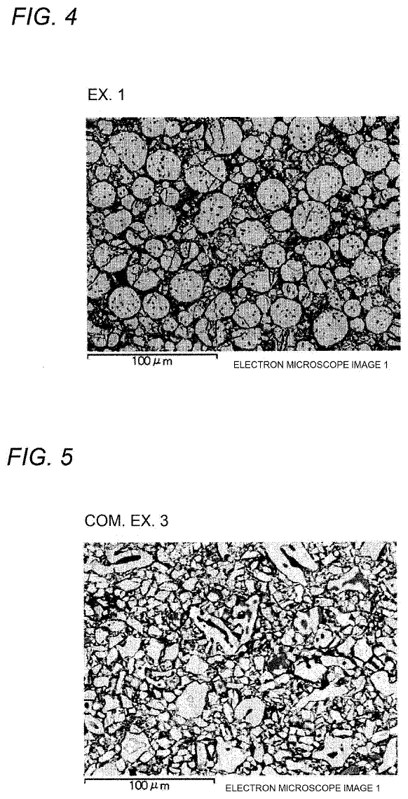

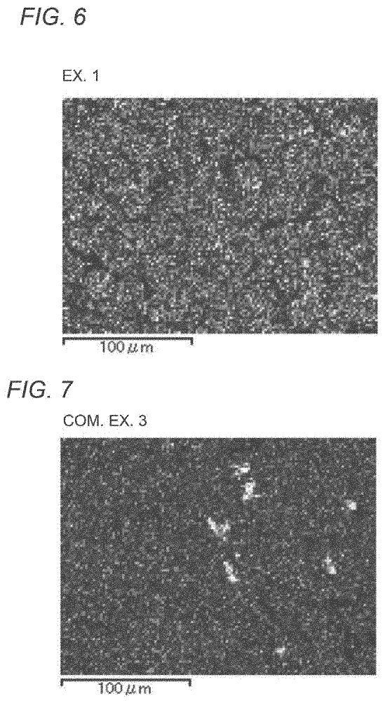

The exposed cross section was observed at a magnification of 500 times, using a SEM, to determine an observation field of view (180 μm by 240 μm region). FIG. 4 shows a SEM image of Example 1, and FIG. 5 shows a SEM image of Comparative Example 3. In the observation field of view, a mapping image was acquired using an energy dispersive X-ray detector (INCA X-sight, available from Oxford Instruments) under the conditions shown below. In the mapping image, the contrast between light and dark was emphasized on the basis of the intensity of the characteristic X-ray of Mn-Ku. FIG. 6 shows a mapping image of Example 1, and FIG. 7 shows a mapping image of Comparative Example 3.

Acceleration voltage: 15 kV

Process time: 4

Dead time: 30 to 40%

Resolution: 128 by 96 pixels

Number of times of scanning: 10 times

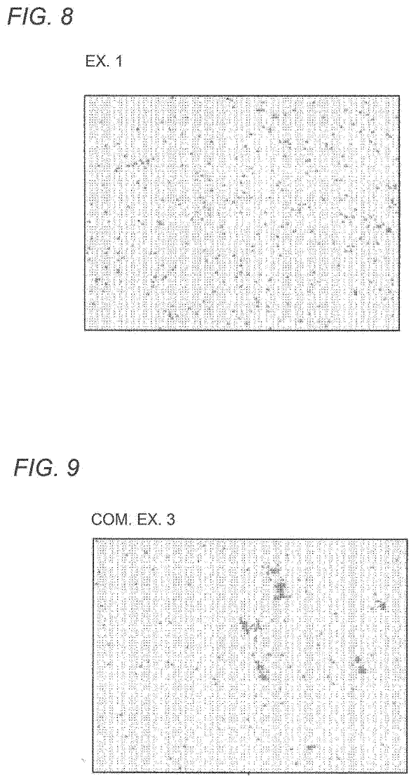

The acquired mapping image was segmented into two: a pixel Pa having an intensity of 50% or higher of the maximum intensity, and a pixel Pb having an intensity of lower than 50%, thereby to acquire a binary mapping image. FIG. 8 shows a binary mapping image of Example 1, and FIG. 9 shows a binary mapping image of Comparative Example 3. In the binary mapping image, a region R where five or more pixels Pa were continuously present with sharing adjacent sides was determined as a Mn localized region, and the number thereof was counted.

### (B) Open Porosity

Ten grams of the baked powder and 0.2 g of an aqueous polyvinyl alcohol solution (concentration: 10 mass %) were put into a mortar and mixed. Subsequently, the mixture was allowed to stand at 110° C. for one hour in a box-type dryer, to remove water, and then passed through a sieve with an aperture of 150 μm, to give a granulated powder. Next, the granulated powder was packed into a 46 mm by 6 mm rectangular mold die, and compression molded at a molding pressure of 100 MPa for 60 seconds, into a molded body of 46 mm long, 6 mm wide, and 6 mm high. The molded body was placed on an alumina plate and baked in an electric furnace at 1200° C. for 2 hours, to give a sintered sample.

The open porosity (P) of the sintered sample was measured in accordance with JIS R 1634.

Specifically, the dry weight, the weight in water, and the weight with saturated water of the sintered sample were measured in accordance with JIS R 1634, and the open porosity was calculated from the following equation:

P=(W3−W1)/(W3−W2)·100,

where P: open porosity (%)
W1: dry weight (g)
W2: weight in water (g)
W3: weight with saturated water (g)

### (C) Electrical Conductivity

The electrical conductivity (S1) at 800° C. of another sintered sample obtained in the same manner as above was measured by a four-terminal method in accordance with JIS R 1661.

Specifically, a platinum paste (TR-7907, available from Tanaka Kikinzoku Co., Ltd.) was applied along the width direction of the sintered sample, symmetrically with respect to the center line that divides the length direction in halves, to form two voltage terminals. The application width was 2 mm, and the separation distance between the voltage terminals was 20 mm. Next, the same platinum paste as above was applied from a position 5 mm away from each of the voltage terminals toward each of both ends of the length direction, to form two current terminals. Then, a platinum wire of 0.3 mm in diameter was wound around each terminal, to form a take-out electrode. The sintered sample with the terminals formed thereon was mounted on a sample holder (ProboStat, available from NorECs AS), and heated in an electric furnace at 800° C. for two hours. In this way, the platinum paste was burned onto the sintered sample. A four-terminal cell was thus obtained. With the obtained four-terminal cell, the electrical conductivity (S1) at 800° C. was measured using an electrochemical measurement system (ModuLab XM, available from Solartron Analytical).

The open porosity (P) and the above electrical conductivity (S1) measured at 800° C. were used to calculate an electrical conductivity (S) of the baked sample, from the following equation.

S=S1/{(100−P)−100},

where S: electrical conductivity
S1: electrical conductivity measured at 800° C.
P: open porosity (%)

TABLE 1

| | | | | Com. | Com. | Com. | Com. |
|---|---|---|---|---|---|---|---|
| Step | | Ex. 1 | Ex. 2 | Ex. 1 | Ex. 2 | Ex. 3 | Ex. 4 |
| Raw | La | La₂O₃ | La₂O₃ | La₂O₃ | La₂O₃ | La₂(CO₃)₃ | La₂O₃ |
| material | Sr | SrCO₃ | SrCO₃ | SrCO₃ | SrCO₃ | SrCO₃ | SrCO₃ |
| | Ca | None | CaCO₃ | CaCO₃ | CaCO₃ | CaCO₃ | CaCO₃ |
| | Mn | MnCO₃ | MnCO₃ | MnCO₃ | MnCO₃ | MnCO₃ | MnCO₃ |
| Slurry | Amount of dispersion | 0.005 | 0.005 | 0.005 | 0.005 | — | 0.005 |
| preparing | added (pts · m) | | | | | | |
| step | Dispersed material D50 | 1.0 | 1.0 | 1.0 | 2.2 | — | 1.0 |
| | (μm) | | | | | | |
| | Viscosity of first slurry | 44 | 41 | 23 | 31 | — | 41 |
| | (mPa · s) | | | | | | |
| Adding | Amount of granulating | 1 | 1 | None | 1 | — | None |
| step | agent added (pts · m) | | | | | | |
| | Viscosity of second | 7 | 5 | 13 | 5 | — | 4 |
| | slurry (mPa · s) | | | | | | |
| Drying | Concentration of metal | 23 | 23 | 63 | 23 | — | 23 |
| step | compounds (mass %) | | | | | | |
| | Drying method | Spray | Spray | Spray | Spray | — | Spray |
| | Dry material D50 | 31 | 41 | 36 | 41 | 13 | 4.1 |
| | (μm) | | | | | | |
| | Dispersed material D50/ | 0.034 | 0.024 | 0.028 | 0.053 | — | 0.228 |
| | Dry material D50 | | | | | | |
| Baking | Baking temperature | 1400 | 1400 | 1400 | 1400 | 1450 | 1400 |
| step | (° C.) | | | | | | |
| Air | Crystal structure | perovskite single phase | | | | | |
| electrode | BET specific surface | 0.180 | 0.096 | 0.150 | 0.190 | 0.200 | 0.340 |
| powder | area (m²/g) | | | | | | |
| | Baked material D50 | 17 | 26 | 20 | 27 | 32 | 13 |
| | (μm) | | | | | | |
| | D90/D10 | 3.4 | 2.7 | 5.6 | 3.0 | 6.1 | 10.4 |
| Molded | Number of Mn localized | 2 | 3 | 6 | 8 | 9 | 6 |
| body | regions R | | | | | | |
| Sintered | Open porosity P (%) | 30 | 29 | 30 | 34 | 35 | 15 |
| sample | Conductivity S (S/cm) | 193 | 183 | 160 | 165 | 118 | 155 |

In the table, the numerical values of the viscosity of the second slurry of Comparative Examples 1 and 4 are those of the slurry prepared in the drying step containing no granulating agent.

Table 1 shows that the number of the Mn localized regions R in the molded body formed from the baked powder (air electrode powder) obtained in Examples 1 and 2 was five or less. Furthermore, the open porosity P of the sintered sample formed from the above baked powder was 29 to 30%, and the conductivity S was 183 to 193 S/cm, exhibiting both a favorable open porosity and a high electrical conductivity. In addition, the specific surface area of the baked powder was 0.05 m²/g or more and 0.3 m²/g or less, and the baked material D50 was 10 μm or more and 35 μm or less. Baked material D50/Dry material D50 was smaller than one, indicating that the reaction proceeded mainly within the dry powder in the baking step.

The specific surface area and the average particle diameter of the baked powder obtained in Comparative Example 1 were equivalent to those of the baked powder obtained in Examples 1 and 2. However, the number of the Mn localized regions R in the molded body formed from the baked powder obtained in Comparative Example 1 was greater than five, showing that the non-perovskite regions were unevenly distributed. Moreover, the conductivity S of the sintered sample formed from the baked powder was lower than that of Examples 1 and 2.

In Comparative Example 1, the metal compounds were sufficiently mixed to be 1 μm in the slurry preparing step, but no granulating agent was added thereto, and the slurry having a metal compound concentration of 25 mass % or more was subjected to the drying step. This resulted in non-uniform composition of the metal compounds in the dry powder. This also resulted in a weak adhesion between the metal compound powders in the dry powder. Therefore, a sufficient solid-phase reaction to make the composition uniform failed to proceed in the subsequent baking step.

In the molded bodies formed from the baked powders obtained in Comparative Examples 2 and 3, too, the number of the Mn localized regions R was greater than five, showing that the non-perovskite regions were unevenly distributed. In addition, the values of the conductivity S of the sintered samples formed from these baked powders were lower than those of Examples 1 and 2.

The results of Comparative Example 2 are considered to be due to the average particle size of the dispersed material in the slurry preparing step being greater than 2 μm. That is, the metal compounds were not pulverized sufficiently in the slurry preparing step, which resulted in a non-uniform composition of the obtained baked powder.

The results of Comparative Example 3 are considered to be due to the mixing of the metal compounds by a dry process, without preparing a slurry. The metal compounds were not pulverised sufficiently and not mixed sufficiently, which resulted in a non-uniform composition of the obtained baked powder. Furthermore, in Comparative Example 3, a perovskite-type crystal structure was obtained by setting the baking temperature higher than that in Examples 1 and 2. This infers that the dry powder obtained in Comparative Example 3 was poor in solid phase reactivity.

In the molded body formed from the baked powder obtained in Comparative Example 4, too, the number of the Mn localized regions R was greater than five, showing that the non-perovskite regions were unevenly distributed. In addition, the conductivity S of the sintered sample formed from this baked powder was lower than those of Examples 1 and 2.

In Comparative Example 4, the metal compounds were finely mixed to be 1 μm in the slurry preparing step, but no granulating agent was added. Therefore, in the dry powder, the adhesion between the metal compounds was weak, and a sufficient solid-phase reaction to make the composition uniform failed to proceed in the subsequent baking step. Baked material D50/Dry material D50 was greater than one, which indicates that in the baking step, the dry powders were sintered to each other. That is, the thermal energy given to the dry powder in the baking step was used not only for the solid phase reaction between the metal compounds but also for the sintering of the dry powders to each other. As a result, the composition of the resultant baked powder becomes non-uniform, and the D90/D10 increased, broadening the particle size distribution of the baked powder. When an air electrode is produced using the baked powder having a broad particle size distribution, the open porosity tends to be low, since the baked powder is sintered densely while the small particles are packed in the gaps between the large particles.

### INDUSTRIAL APPLICABILITY

The metal composite oxide of the present invention is excellent in electrical conductivity, and therefore, can be suitably used as a powder for an air electrode in a solid oxide fuel cell.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A powder for an air electrode in a solid oxide fuel cell, the powder consisting of:
a metal composite oxide having a perovskite-type single phase crystal structure represented by a following general formula:
A1₁₋ₓA2ₓBO_{3-δ},
where the element A1 is at least one selected from the group consisting of La and Sm, the element A2 is at least one selected from the group consisting of Ca, Sr, and Ba, the element B is at least one selected from the group consisting of Mn, Fe, Co, and Ni, 0<x<1, and the δ is an oxygen deficiency amount, wherein
when a cross section of a molded body obtained by compression molding the powder is observed at a magnification of 500 times, and a characteristic X-ray intensity of the element B is measured by an energy dispersive X-ray spectroscopy, the number of regions each having an intensity of 50% or higher of a maximum of the characteristic X-ray intensity of the element B and occupying 0.04% by area or more of the observation field of view is five or less.

2. The powder for an air electrode in a solid oxide fuel cell according to claim 1, wherein
the element A1 includes La,
the element A2 includes Sr, and
the element B includes Mn.

3. The powder for an air electrode in a solid oxide fuel cell according to claim 1, wherein the powder has a specific surface area based on a BET method of 0.05 m²/g or more and 0.3 m²/g or less.

4. The powder for an air electrode in a solid oxide fuel cell according to claim 1, wherein the powder has an average particle diameter of 10 μm or more and 35 μm or less.

5. A method of producing a powder for an air electrode in a solid oxide fuel cell, the powder having a perovskite-type single phase crystal structure represented by a following general formula:
A1₁₋ₓA2ₓBO_{3-δ},
where the element A1 is at least one selected from the group consisting of La and Sm, the element A2 is at least one selected from the group consisting of Ca, Sr, and Ba, the element B is at least one selected from the group consisting of Mn, Fe, Co, and Ni, 0<x<1, and the δ is an oxygen deficiency amount,
the method comprising:
a slurry preparing step of mixing different kinds of metal compounds in a powder form each containing one of the element A1, the element A2, and the element B, with a dispersion medium, to prepare a slurry in which an average particle diameter of the metal compounds is 0.5 μm or more and 2 μm or less,
an adding step of adding a granulating agent to the slurry,
a drying step of removing the dispersion medium in the slurry after the adding step, to obtain a dry powder, and
a baking step of baking the dry powder, wherein
in the slurry subjected to the drying step, a total concentration of the different kinds of metal compounds is 10 mass % or more and below 25 mass %.

6. The method of producing a powder for an air electrode in a solid oxide fuel cell according to claim 5, wherein a dispersant is further mixed in the slurry preparing step.

7. The method of producing a powder for an air electrode in a solid oxide fuel cell according to claim 5, wherein the dry powder obtained in the drying step has an average particle diameter of 10 μm or more and 50 μm or less.

8. The method of producing a powder for an air electrode in a solid oxide fuel cell according to claim 5, wherein a ratio of the average particle diameter of the metal compounds included in the slurry obtained in the slurry preparing step to the average particle diameter of the dry powder obtained in the drying step is 0.015 or more and 0.05 or less.

9. The method of producing a powder for an air electrode in a solid oxide fuel cell according to claim 5, wherein a baking temperature in the baking step is 1200° C. or higher and 1500° C. or lower.

10. The method of producing a powder for an air electrode in a solid oxide fuel cell according to claim 5, wherein the dispersion medium is removed by spray-drying in the drying step.
